(19) United States
(12) Patent Application Publication
(10) Pub. No.: US 2022/0343025 A1
(43) Pub. Date: Oct. 27, 2022

(54) PROCESS FOR MANAGING THE RIGHTS AND ASSETS OF A USER ON A BLOCKCHAIN

(71) Applicant: BPCE, Paris (FR)

(72) Inventors: José Luu, Igny (FR); Cyril Vignet, Paris (FR)

(21) Appl. No.: 17/765,166

(22) PCT Filed: Sep. 29, 2020
(86) PCT No.: PCT/EP2020/077261

§ 371 Date: Mar. 30, 2022

(30) Foreign Application Priority Data
Sep. 30, 2019 (FR) 1910814

(51) Int. Cl. G06F 21/62; H04L 9/32; H04L 9/00

(52) U.S. Cl. CPC G06F 21/6272; H04L 9/3263; H04L 9/50

(57) ABSTRACT

The invention relates to a process for managing the rights and assets of a user in a block chain. The user accesses the rights and assets using a pair of private and public keys connected with a terminal. The process provides for the prior storage of the rights and assets of the user in a digital safe connected to the user. The process further allows the user to access his/her rights and assets, for collection of the public key, associating the public key with the user, storing and associating the public key with the safe of the user in order to allow authentication of the user by the digital safe using the public key.

### CROSS-REFERENCE TO RELATED APPLICATIONS

This application claims the benefit of International application number PCT/EP2020/077261, filed Sep. 29, 2020 and French patent application number 1910814, filed on Sep. 30, 2019, the entire contents of which are incorporated herein by reference.

### TECHNICAL FIELD

The invention relates to a process for managing the rights and assets of a user on a blockchain, as well as an architecture comprising means for implementing such a process.

### BACKGROUND

Blockchains are technologies that enable their users to store and transmit data in a secure manner and without any central control body, thanks to a distributed database whose information sent by the users and internal links are verified and grouped at regular time intervals in blocks, thereby forming a chain (see in particular the article “Blockchain”” on the site of the collaborative encyclopaedia Wikipedia® and the article of the online newspaper “Le Journal du Net” available at the address https://www.journaldunet.com/economie/finance/1195520-blockchain-avril-2019/).

This fast-growing technology is used in particular to enable the users to carry out transactions, validated by a consensus mechanism between nodes in the chain (called “miners”), and finds application more particularly in the creation and management of virtual currencies, or crypto-currencies, such as for example Bitcoin®, Ether®, Monero® or Peercoin® (or PPcoin®).

Blockchains are secured by a cryptographic system, and are accessible by users thanks to private keys which, for security reasons, are generally known only to them.

In particular, this cryptography system is based on a pair of keys related together by mathematical functions, including a private key, that the user must keep secret, and a public key, which represents the cryptographic address of the user. These blockchains guarantee that a transaction can be issued only by the owner of the private key, and only the public key is communicated to the receiver of said transaction.

In blockchains, the rights and assets are materialised in a digital form and associated to the public keys, and only the users holding the corresponding private keys can manage said rights and assets.

The keys are generally complex to remember, all the more so since a same user can sometimes hold several ones, to access several blockchains and/or a same blockchain. Thus, it is easy for a user to lose his keys, and therefore all access to his rights and assets on a blockchain.

To avoid the loss of their keys, users can in particular save them in a mobile computer medium, such as for example a mobile phone or a USB (standing for “Universal Serial Bus”) key, or in a third-party server.

Nonetheless, these solutions are not fully satisfactory, in that the risk of loss and/or theft of the private keys remains considerable.

### SUMMARY OF THE INVENTION

The invention aims to improve the prior art by providing in particular a process to enable a user to easily manage his rights and assets on a blockchain, in particular by enabling him to preserve access thereto even in the event of loss and/or theft.

To this end, according to a first aspect, the invention provides a process for managing the rights and assets of a user on a blockchain, said user accessing said rights and assets by means of at least one pair of private and public keys related to a terminal of said user, said process providing for the prior registration of the rights and assets of the user in a digital safe related to said user, said process further providing, in order to allow the user to access his rights and assets, for:
the collection of the public key;
the association of the public key to said user;
the registration and the association of the public key to the safe of the user, in order to allow the authentication of the user by the digital safe by means of the public key.

According to a second aspect, the invention provides an architecture for managing the rights and assets of a user on a blockchain, said user accessing said rights and assets by means of at least one pair of private and public keys related to a terminal of said user, said architecture comprising:
a platform for providing a digital safe service, said platform comprising means for registering the rights and assets of the user in a digital safe related to said user;
a central platform comprising means for:
interacting with a terminal of the user, in order to collect the public key;
associating the public key to the user;
interacting with the platform for providing the digital safe service to register the public key therein by associating it to the safe of the user, in order to allow the authentication of said user by the digital safe by means of said public key.

### BRIEF DESCRIPTION OF THE DRAWING

Other particularities and advantages of the invention will appear in the following description, made with reference to the appended FIGURE,

FIG. 1 representing an architecture for implementing a process according to an embodiment of the invention.

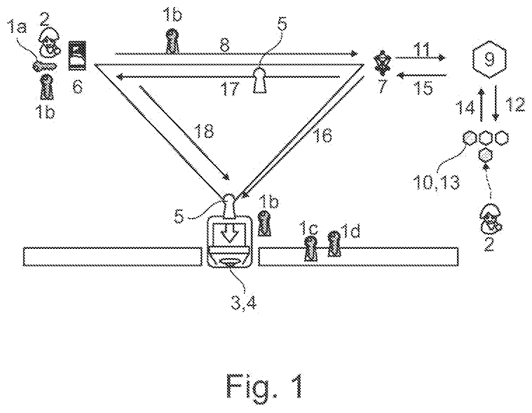

### DETAILED DESCRIPTION

Referring to this FIGURE, a process is described hereinbelow for managing the rights and assets of a user 2 on a blockchain, to which said user accesses by means of at least one pair of private 1a and public 1b keys, as well as an architecture comprising means for implementing such a process.

The user 2 may be a natural person, in particular an individual holding rights and assets for personal use on the blockchain, or a legal person, for example a representative of a company holding rights and assets on said blockchain.

In particular, the keys 1a, 1b allows the user 2 to perform cryptographic signatures during a participation in an operational function in the blockchain, and are created during the first connection of said user to said blockchain. In particular, the private key 1a is kept secret by the user 2, and the public key 1b allows said user to interact with the blockchain and/or another user to perform transactions.

The keys 1a, 1b are related to a terminal 6 of the user 2, and are created in said terminal under the control of said user. Therefore, the private key 1a never leaves the terminal 6 of the user 2, which guarantees optimum security to said user.

For this purpose, the terminal 6 may comprise an application arranged so as to allow the user 2 to create the pair of keys 1a, 1b under the control of said user.

The terminal 6 may be a mobile terminal, in particular a so-called smart mobile phone (“smartphone”), as represented in the FIGURE. The terminal 6 may also be a digital tablet, or else a personal assistant (PDA, standing for “Personal Digital Assistant”).

The process provides for the prior registration of the rights and assets of the user 2 in a digital safe 3 related to the user 2. For this purpose, the architecture comprises a platform 4 for providing such a service, said platform comprising means for registering the rights and assets of the user 2 in such a safe 3.

Beforehand, the process provides for the creation of a digital safe 3 related to the user 2, in particular by an administrator of the digital safe service.

For this purpose, the platform 4 comprises means to allow an administrator to create a safe 3 for the user 2, for example by means of a suitable programming interface (API, standing for “Application Programming Interface”).

In particular, the digital safe platform 4 may comprise means for creating a digital safe 3 in the form of a smart contract type (“Smart contract”) computer protocol, said smart contract being accessible to the user 2 by means of a public digital address 5.

In particular, the user 2 may comprise several pairs of keys 1a, 1b for access to a same blockchain and/or to several different blockchains, the platform 4 being adapted to register all of the rights and assets of said user related to said keys in his safe 3.

To allow the user 2 to access his rights and assets registered in his safe 3, the process provides for the collection of the public key 1b created on the terminal 6 of said user.

For this purpose, the architecture comprises a central platform 7 which comprises means for interacting with the terminal 6 of the user 2, in order to collect the public key 1b.

Referring to the FIGURE, the terminal 6 sends to the central platform 7 a message 8 containing in particular the public key 1b, said platform being arranged so as to receive said message and extract said public key therefrom using suitable collection means.

Afterwards, the process provides for the association of the collected public key 1b to the user 2, the central platform 7 comprising means adapted to carry out such an association.

For this purpose, the process provides for the identification of the user 2 before a third-party identification platform 9, said identification being performed in parallel with the collection of the public key 1b to associate said public key to said user.

Referring to the FIGURE, the central platform 7 comprises association means which are arranged so as to interact, in parallel with the collection of the public key 1b, with such a third-party identification platform 9 comprising means for identifying the user 2.

The process provides for the provision, by the user 2 to the third-party identification platform 9, of a digital identity allowing said user to access a third-party service 10 related to said platform, the identification of the user 2 being carried out by means of said digital identity.

The third-party identification platform 9 may be a FranceConnect® type legal platform, which allows a user 2 to identify himself simultaneously before several third-party services 10 related to said platform by providing only one digital identity amongst those allowing access to each of these services.

Thus, thanks to such a platform 9, a user 2 can access sensitive online services 10, for example a service for paying taxes (impots.gouv.fr), social security (ameli.fr), or management of secure credentials (ants.gouv.fr), by limiting connection sessions, which allows reducing the risk of theft of his digital identities. Moreover, such a platform 9 does not remember the digital identity used by the user 2 to sign in, which limits even more the risk of fraud of said digital identity.

Therefore, the use of such a platform 9 proves to be particularly advantageous to securely identify the user 2 and associate the public key 1b to him.

Referring to the FIGURE, the association means of the central platform 7 are arranged so as to send to the third-party identification platform 9 a query 11 to ask the user 2 to provide a digital identity allowing him to access one of the third-party services 10 related to said platform, in order to identify said user by means of said digital identity.

In a known manner, after reception of the query 11, the platform 9 can send to the user 2, in particular on his terminal 6, a message 12 to display on said terminal an interactive page specific to said platform, said page comprising interactive buttons 13 representing each of the services 10, in order to allow the user to select the digital identity he wishes to provide by selecting the button 13 of the corresponding service 10.

Once the suitable service 10 has been selected, the platform 9 can display on the terminal 6 a field that the user 2 must fill in with the corresponding digital identity, as well as a confirmation button that the user 2 activates once said field is completed to send to said platform a message 14 containing said digital identity.

Once the identification of the user 2 has been performed, the process provides for associating the public key 1b communicated by the terminal 6 to the digital identity provided by said user.

Referring to the FIGURE, after reception of the message 14, the third-party identification platform 9 sends to the central platform 7 a notification 15 comprising the digital identity of the user 2, the association means of said central platform being arranged so as to associate said digital identity to the public key 1b.

Afterwards, the process provides for the registration and association of the public key 1b to the safe 3 of the user 2, in order to allow said user to authenticate himself subsequently before the digital safe 3 by means of said public key, and thus to access his rights and assets on the blockchain.

For this purpose, the central platform 7 comprises means for interacting with the platform 4 for providing a digital safe service, in order to register the public key 1b therein by associating it to the safe 3 of the user 2.

In particular, the central platform 7 can send to the platform 4 a message 16 comprising the public key 1b and the digital identity of the user 2, in order to allow the platform 4 to identify the corresponding safe 3 and to associate said public key thereto.

For this purpose, the process can provide, during the creation of the safe 3, for relating said safe to the user 2 by associating the above-mentioned digital identity to the digital address 5 of said safe, so as to use said digital identity to register the public key 1b in said safe.

To this end, the platform 4 may include means for allowing an administrator to relate the safe 3 to its user 2 by associating the digital identity, in particular entered by the user 2, to the digital address 5 of said safe 3.

Furthermore, the registration means of the central platform 7 may be arranged so as to use the digital identity communicated by the third-party platform 9 to obtain the digital address 5 of the safe 3 of the user 2, and thus register the public key 1b therein.

Once the public key 1b has been registered, the process provides for sending on the terminal 6 of the user 2 a link for accessing his digital safe 3, in particular the public address 5 of the smart contract implementing said safe.

For this purpose, the central platform 7 comprises means for sending to the terminal 6 a message 17 comprising such a link 5 to allow the user 2 to access his rights and assets registered in the safe 3.

In particular, the link may be arranged, when the user 2 activates it, so as to enable the display on his terminal 6 of a user interface allowing him to send the public key 1b from his terminal 6 to the platform 4, in particular through a message 18, in order to authenticate before the safe 3 by means of said public key, and thus access his rights and assets on the blockchain.

Moreover, the platform 4 may be arranged, after having authorised the access of the user 2 to his rights and assets, so as to send to said user a message confirming said access.

Advantageously, the user 2 can associate several terminals 6 to his digital safe 3, in particular by repeating the above-described process to register the public keys 1b, 1c, 1d of each of said terminals. Thus, the user 2 can access his rights and assets by means of several terminals 6, which allow him in particular to preserve access to his rights and assets even in the event of loss and/or theft of one of said terminals.

To protect the user 2 against the loss and/or theft of his rights and assets on the blockchain, in particular in the event of loss and/or theft of his terminal, the process can allow the user 2 to register a new terminal 6 in place of the old one, in order not only to allow him to access his rights and assets again, but also to prevent a third person from accessing them by means of the old terminal.

For this purpose, the process may provide for registering the public key 1b in place of a possible old public key 1c, 1d related to an old terminal of the user 2 and previously associated to the safe 3 of said user, and the central platform 7 may comprise means for performing such a registration. Thus, the user 2 can easily and safely destroy a public key 1b, 1c, 1d of a terminal 6 that he no longer uses.

What is claimed is:

1. A process for managing the rights and assets of a user on a blockchain, the user accessing the rights and assets using a pair of a private key and a first public key related to a first terminal of the user, the process providing for the prior registration of the rights and assets of the user in a digital safe related to the user, the process further providing, for:
collection of the first public key;
association of the first public key to the user;
registration and the association of the first public key to the safe of the user, to allow the authentication of the user by the digital safe using the first public key.

2. The process according to claim 1, providing for the identification of the user before a third-party identification platform, the identification being performed in parallel with the collection of the first public key to associate the first public key to the user.

3. The process according to claim 2, providing for the provision, by the user to the third-party identification platform, of a digital identity allowing the user to access a third-party service related to the platform, the identification of the user being carried out using the digital identity, the process providing for associating the first public key to the digital identity.

4. The process according to claim 3, providing for relating the safe to the user by associating the digital identity of the user to a digital address of the safe, the process providing for using the digital identity to register the first public key in the safe.

5. The process according to claim 1, providing for sending on the terminal of the user a link for accessing the digital safe after registration of the first public key.

6. The process according to claim 1, providing for registering a second public key in place of the first public key related to the first terminal of the user and previously associated to the safe of the user.

7. An architecture for managing the rights and assets of a user on a blockchain, the user accessing the rights and assets using a pair of a private key and a first public key related to a first terminal of the user, the architecture comprising:
a first platform for providing a digital safe service, the first platform comprising a register for registering the rights and assets of the user in a digital safe related to the user;
a central platform configured to:
interact with the first terminal of the user, to collect the first public key;
associate the first public key to the user;
interact with the first platform for providing the digital safe service to register the first public key by associating the first public key to the safe of the user, to allow the authentication of the user by the digital safe using the public key.

8. The architecture according to claim 7, wherein the central platform is configured to interact with a third-party identification platform configured for identifying the user, the interaction between the central platform and the third-party identification platform being performed in parallel with the collection of the first public key, to associate the first public key to the user.

9. The architecture according to claim 8 wherein the central platform is configured to send to the third-party identification platform a query to ask the user to provide a digital identity to allow access to a third-party service related to the third party platform, to identify the user using the digital identity, the central platform being configured to associate the first public key to the digital identity.

10. The architecture according to claim 9, wherein the first platform is configured to relate the safe to the user by associating the digital identity of the user to a digital address of the safe, the central platform being configured to use the digital identity to register the first public key in the safe.

11. The architecture according to claim 7, wherein the central platform is configured to send on the first terminal of the user a link for accessing his digital safe after registration of the first public key.

12. The architecture according to claim 7, wherein the central platform is configured to register a second public key in place of the first public key related to an old terminal of the user and previously associated to the safe of the user.
